(19) United States
(12) Patent Application Publication
(10) Pub. No.: US 2017/0102295 A1
(43) Pub. Date: Apr. 13, 2017

(54) FAULT DIAGNOSTIC SYSTEM

(71) Applicant: Sumitomo Heavy Industries, Ltd., Tokyo (JP)

(72) Inventors: Mikio Komatsu, Aichi (JP); Kota Suzuki, Aichi (JP)

(21) Appl. No.: 15/283,859

(22) Filed: Oct. 3, 2016

(30) Foreign Application Priority Data
Oct. 13, 2015 (JP) 2015-202123

(51) Int. Cl. G01M 99/00; G01H 1/00

(52) U.S. Cl. CPC G01M 99/008; G01H 1/003

(57) ABSTRACT

The fault diagnostic system includes a sensor which is provided in each of a plurality of diagnosis target devices and detects diagnosis target information of the corresponding diagnosis target device, and a diagnosis unit which is provided for one or a plurality of diagnosis target devices and determines whether or not abnormality occurs in the corresponding diagnosis target device based on the diagnosis target information detected by the sensor. The diagnosis unit outputs an abnormality determination result to the outside, and when a specific condition is established, outputs diagnosis target information detected by the sensor after the specific condition is established.

### RELATED APPLICATIONS

Priority is claimed to Japanese Patent Application No. 2015-202123, filed Oct. 13, 2015, the entire content of which is incorporated herein by reference.

### BACKGROUND

Technical Field

A certain embodiment of the present invention relates to a fault diagnostic system.

Description of Related Art

For example, a fault diagnostic system which finds a fault in a device, such as a motor, a gear motor, or a gear box, is known. Hitherto, for example, a fault diagnostic system described in the related art has been suggested.

### SUMMARY

According to an embodiment of the invention, there is provided a fault diagnostic system including a sensor which is provided in each of a plurality of diagnosis target devices and detects diagnosis target information of the corresponding diagnosis target device, and a diagnosis unit which is provided for one or a plurality of diagnosis target devices and determines whether or not abnormality occurs in the corresponding diagnosis target device based on the diagnosis target information detected by the sensor. The diagnosis unit outputs a determination result to the outside, and when a specific condition is established, outputs diagnosis target information detected by the sensor after the specific condition is established.

### BRIEF DESCRIPTION OF THE DRAWINGS

FIG. 1 is a schematic view showing the configuration of a fault diagnostic system according to an embodiment.

FIG. 2 is a block diagram showing the functions and configuration of a diagnosis unit of FIG. 1.

FIG. 3 is a block diagram showing the functions and configuration of a reception station of FIG. 1.

### DETAILED DESCRIPTION

In general, the fault diagnostic system includes one diagnosis unit for one or a plurality of diagnosis target devices. The diagnosis unit stores diagnosis target information (for example, information relating to vibration) detected by a sensor attached to the diagnosis target device therein, and analyzes the stored diagnosis target information through predetermined processing. For this reason, the diagnosis unit requires a comparatively large memory for storing the diagnosis target information, and if the number of diagnosis units increases with an increase in the number of diagnosis target devices, the fault diagnostic system becomes expensive.

There is a need for a fault diagnostic system capable of accurately detecting and analyzing a fault in a diagnosis target device while being comparatively inexpensive.

Arbitrary combinations of the above constituent elements, and those obtained by substituting the constituent elements or expressions of the invention with each other between methods, devices, systems, or the like are also effective as the aspects of the invention.

According to an embodiment of the invention, it is possible to provide a fault diagnostic system capable of accurately detecting and analyzing a fault in a diagnosis target device while being comparatively inexpensive.

Hereinafter, the same or equivalent constituent elements, members, and processes illustrated in respective drawings will be represented by the same reference numerals, and overlapping description will be appropriately omitted. The dimensions of the members in the respective drawings are appropriately illustrated in an enlarged or reduced manner in order to make the invention easily understood. When an embodiment is described in the respective drawings, some members which are not important will be omitted.

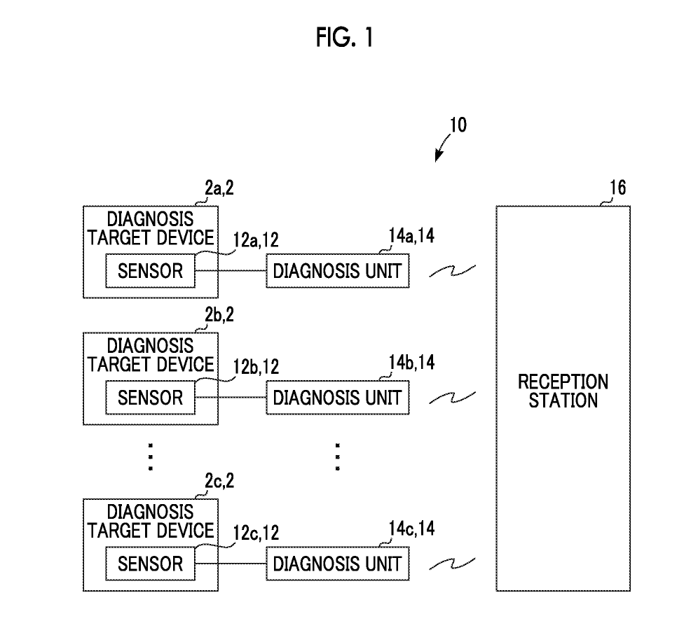

FIG. 1 is a schematic view showing the configuration of a fault diagnostic system 10 according to an embodiment. The fault diagnostic system 10 detects abnormality of a diagnosis target device 2a, a diagnosis target device 2b, and a diagnosis target device 2c collectively referred to as a diagnosis target device 2, and supports analysis of a fault. In this embodiment, the diagnosis target device 2 is a gear motor. The diagnosis target device 2 is, for example, a motor, a gear box, or other devices.

The fault diagnostic system 10 includes sensors 12a, 12b, and 12c collectively referred to as a sensor 12, diagnosis units 14a, 14b, and 14c collectively referred to as a diagnosis unit 14, and a reception station 16. In this embodiment, the sensors 12a, 12b, and 12c are respectively connected to the diagnosis units 14a, 14b, and 14c in a wired manner. The diagnosis units 14a, 14b, and 14c are connected to the reception station (external device) 16 in a wireless manner. The diagnosis units 14a, 14b, and 14c may be connected to the reception station 16 in a wired manner.

The sensors 12a, 12b, and 12c are respectively attached to the diagnosis target devices 2a, 2b, and 2c. In this embodiment, the sensor 12 is a vibration sensor, detects vibration generated in the corresponding diagnosis target device 2, generates vibration information indicating the magnitude of vibration, and transmits the vibration information to the corresponding diagnosis unit 14. In FIG. 1, although a case where one sensor 12 is attached to each diagnosis target device 2 is shown, two or more sensors 12 may be attached to each diagnosis target device 2. Of course, two or more sensors 12 may be attached only to some diagnosis target devices 2. In regard to the attachment position of the sensor 12 in the diagnosis target device 2, a position suitable for abnormality detection may be determined by an experiment, a simulation, or the like.

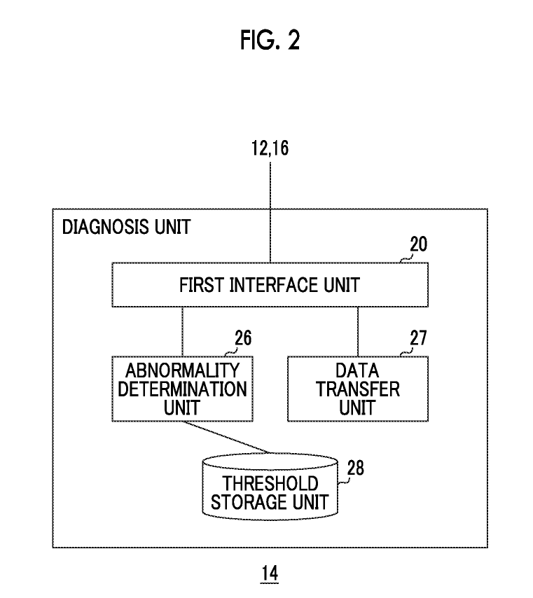

The diagnosis units 14a, 14b, and 14c respectively determine whether or not abnormality occurs in the diagnosis target devices 2a, 2b, and 2c based on the vibration information sent from the sensors 12a, 12b, and 12c, and transmit determination results to the reception station 16. If a transmission request for vibration information is received from the reception station 16, the diagnosis unit 14 transmits the vibration information sent from the sensor 12 to the reception station 16. The detailed functions and configuration of the diagnosis unit 14 will be described in detail referring to FIG. 2.

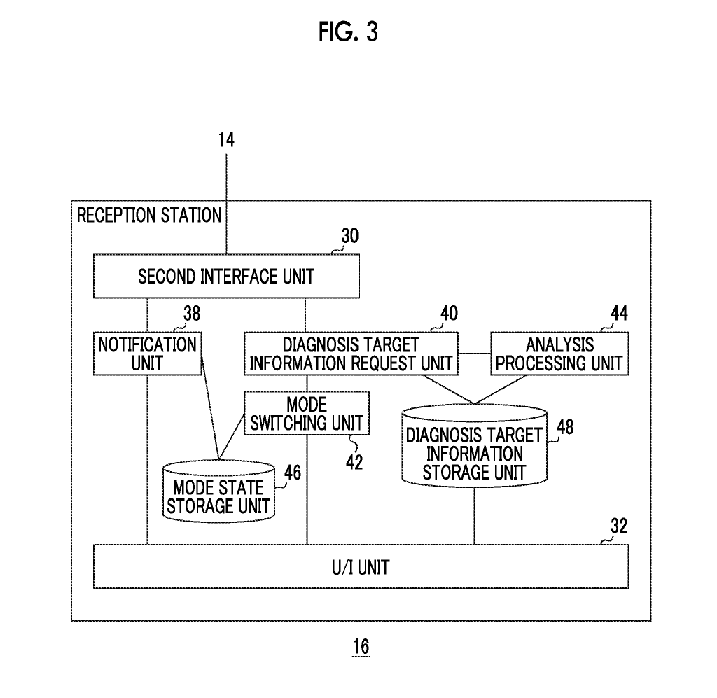

The reception station 16 notifies the user of the determination results for each diagnosis target device 2 sent from each diagnosis unit 14. The reception station 16 transmits a transmission request for vibration information to the diagnosis unit 14 according to a user's instruction and analyzes the vibration information. As described above, since the reception station 16 and the diagnosis unit 14 are connected in a wireless manner, even if the reception station 16 is disposed at a place comparatively separated from the diagnosis unit 14, a situation in which wiring becomes an obstacle is not generated. Conversely, since a situation in which wiring becomes an obstacle is not generated, the reception station 16 can be displaced at a place separated from the diagnosis unit 14, and consequently, the diagnosis target device 2. The detailed functions and configuration of the reception station 16 will be described in detail referring to FIG. 3.

FIG. 2 is a block diagram showing the functions and configuration of the diagnosis unit 14 of FIG. 1. Although each block shown in the drawing can be realized using elements or machines including a CPU and a memory of a computer by hardware or is realized by a computer program or the like by software, here, functional blocks which are realized by cooperation of hardware and software are drawn. Accordingly, it will be understood by those skilled in the art that these functional blocks can be realized by a combination of hardware and software in various ways. The same applies to a subsequent block diagram.

In FIG. 2, one among a plurality of diagnosis units 14 is shown representatively. The diagnosis unit 14 includes a first interface unit 20, an abnormality determination unit 26, a data transfer unit 27, and a threshold storage unit 28. The first interface unit 20 executes communication processing with the sensor 12 or the reception station 16.

The abnormality determination unit 26 determines whether or not abnormality occurs in the diagnosis target device 2 based on the vibration information sent from the sensor 12 substantially in real time. Specifically, the abnormality determination unit 26 confirms the vibration information sent from the sensor 12 at regular intervals (for example, intervals of 0.1 second), determines that abnormality does not occur in the diagnosis target device 2 in a case where the magnitude of vibration indicated by the vibration information does not exceed an abnormality threshold stored in the threshold storage unit 28, and determines that abnormality occurs in the diagnosis target device 2 in a case where the magnitude of vibration indicated by the vibration information exceeds the abnormality threshold. At this time, if minimum vibration information necessary for substantially real-time abnormality determination by the abnormality determination unit 26 is merely temporarily stored in the diagnosis unit 14, the diagnosis unit 14 basically discards the vibration information after the determination processing is completed without storing the vibration information. A determination method by the abnormality determination unit 26 is not limited to the above-described example, and for example, abnormality determination may be performed based on an average value or a peak value of vibration information for a predetermined period (for example, ten seconds), or filtering processing or the like may be appropriately performed. In this case, the diagnosis unit 14 temporarily stores the vibration information for the predetermined period, but discards the temporarily stored vibration information after the determination processing is completed.

The abnormality determination unit 26 transmits a determination result of whether or not abnormality occurs to the reception station 16 through the first interface unit 20. The abnormality determination unit 26 may transmit the determination result to the reception station 16 only in a case where it is determined that abnormality occurs, that is, only in a case where it is detected that abnormality occurs. In a case of transmitting the determination result that abnormality occurs, the vibration information used for the determination may be transmitted to the reception station 16 along with the determination result.

If a transmission request for vibration information is transmitted from the reception station 16, the data transfer unit 27 receives the transmission request through the first interface unit 20. The data transfer unit 27 transmits vibration information generated by the sensor 12 after the reception of the transmission request to the reception station 16 through the first interface unit 20. That is, the data transfer unit 27 transfers the vibration information transmitted from the sensor 12 to the reception station 16. In this case, the diagnosis unit 14 merely temporarily stores the vibration information to be transferred and discards the vibration information after the transfer to the reception station 16.

The threshold storage unit 28 stores the “abnormality threshold” for use in the determination by the abnormality determination unit 26. The abnormality threshold is set to a value obtained by multiplying a reference value (normal value) by a certain coefficient (for example, 1.5, 2.0, or the like). The coefficient may be set to an appropriate value by the knowledge or experience of the user, an experiment, or the like. The reference value (normal value) may be set to an appropriate value by the knowledge or experience of the user, an experiment, or the like, or the diagnosis unit 14 may automatically measure normal vibration information for a predetermined period and may set an average value for the measurement period as a reference value. The abnormality threshold may be different for the diagnosis target devices 2. In a case where two or more sensors 12 are attached to one diagnosis target device 2, the abnormality threshold may be different for vibration information sent from the respective sensors 12. That is, the abnormality threshold may be different according to the attachment positions of the sensors 12.

FIG. 3 is a block diagram showing the functions and configuration of the reception station 16 of FIG. 1. The reception station 16 includes a second interface unit 30, a user interface (U/I) unit 32, a notification unit 38, a diagnosis target information request unit 40, a mode switching unit 42, an analysis processing unit 44, a mode state storage unit 46, and a diagnosis target information storage unit 48.

The second interface unit 30 executes communication processing with the diagnosis unit 14. The U/I unit 32 is engaged in information display and an operation input.

The mode state storage unit 46 stores information indicating the state of the reception station 16. Specifically, the mode state storage unit 46 stores either a “detection mode” or an “analysis mode”. The “detection mode” is a mode for detecting abnormality occurring in the diagnosis target device 2. The “analysis mode” is a mode for analyzing the vibration information and specifying the type of abnormality, a part where abnormality occurs, or the like.

The notification unit 38 receives the determination result transmitted from the diagnosis unit 14 through the second interface unit 30. In particular, the notification unit 38 receives the determination result transmitted from the diagnosis unit 14 when the mode state stored in the mode state storage unit 46 is the “detection mode” and does not receive the determination result transmitted from the diagnosis unit 14 when the mode state is the “analysis mode”.

The notification unit 38 notifies the user of the received determination result through the U/I unit 32. For example, the notification unit 38 displays the determination result on a predetermined screen or outputs the determination result to the outside as a signal to notify the user of the determination result. For example, the notification unit 38 outputs the determination result by sound to notify the user of the determination result.

The user can designate the diagnosis unit 14, which should transmit the vibration information, through the U/I unit 32. For example, the user confirms the determination result notified by the notification unit 38, and if there is the diagnosis unit 14 in which abnormality occurs, designates the diagnosis unit 14.

The diagnosis target information request unit 40 receives the designation of the diagnosis unit 14, which should transmit the vibration information, through the U/I unit 32. The diagnosis target information request unit 40 transmits a transmission request for vibration information to the designated diagnosis unit 14. If the vibration information is transmitted based on the transmission request, the diagnosis target information request unit 40 stores the vibration information in the diagnosis target information storage unit 48.

If the diagnosis target information request unit 40 transmits the transmission request to the diagnosis unit 14, the mode switching unit 42 updates data stored in the mode state storage unit 46 from the “detection mode” to the “analysis mode”.

The analysis processing unit 44 analyzes the vibration information stored in the diagnosis target information storage unit 48 in detail. Specifically, the analysis processing unit 44 executes fast Fourier transform (FFT) for a vibration waveform based on the vibration information or executes FFT for an envelope of the vibration waveform. The analysis processing unit 44 displays an analysis result on a predetermined display unit through the U/I unit 32. The user confirms the analysis result displayed on the display unit, thereby specifying the type of abnormality occurring in the diagnosis target device 2, a part where abnormality occurs, or the like.

The operation of the fault diagnostic system 10 configured as above will be described. Here, a case where a fault occurs in the diagnosis target device 2b among a plurality of diagnosis target devices 2 will be described as an example.

The diagnosis unit 14 performs abnormality determination of whether or not abnormality occurs in the diagnosis target device 2 based on the vibration information sent from the sensor 12 substantially in real time. If it is detected that the magnitude of vibration indicated by the vibration information sent from the sensor 12b exceeds the abnormality threshold, the diagnosis unit 14b transmits, to the reception station 16, a determination result indicating that abnormality occurs. The diagnosis units 14a and 14c transmit, to the reception station 16, a determination result that abnormality does not occur.

The notification unit 38 of the reception station 16 displays the determination result from each diagnosis unit 14 on a predetermined display unit. The user confirms the display unit, and if it is detected that abnormality occurs in the diagnosis unit 14b, the user performs an input so as to allow the vibration information of the diagnosis unit 14b to be transmitted through the U/I unit 32. The diagnosis target information request unit 40 transmits a transmission request for vibration information to the diagnosis unit 14b designated by the user. The mode switching unit 42 updates data of the mode state storage unit 46 from the “detection mode” to the “analysis mode”.

If the transmission request is received, the data transfer unit 27 of the diagnosis unit 14b transmits the vibration information of the diagnosis target device 2b subsequently detected by the sensor 12b to the reception station 16.

The analysis processing unit 44 of the reception station 16 receives the vibration information transmitted from the diagnosis unit 14b. At this time, although the determination results are continuously sent from the diagnosis units 14a and 14c, since data of the mode state storage unit 46 is the “analysis mode”, the notification unit 38 does not receive the determination results.

The analysis processing unit 44 executes predetermined analysis processing for the received vibration information and displays an analysis result on a predetermined display unit through the U/I unit 32. The user confirms the analysis result displayed on the display unit, thereby specifying the type of abnormality occurring in the diagnosis target device 2b, a part where abnormality occurs, or the like.

According to the fault diagnostic system 10 of the embodiment described above, the diagnosis unit 14 performs abnormality determination based on the vibration information sent from the sensor 12 substantially in real time. At this time, the minimum vibration information necessary for substantially real-time abnormality determination by the abnormality determination unit 26 is merely temporarily stored in the diagnosis unit 14, and the diagnosis unit 14 basically discards the vibration information without storing the vibration information. In a case of analyzing the vibration information in detail, detailed analysis is not performed in the diagnosis unit 14, and the vibration information is transmitted (transferred) to the reception station 16 and is analyzed in the reception station 16 in detail. In addition, instead of transmitting stored vibration information, vibration information detected after there is a request is transmitted and discarded after transmission. For this reason, when analyzing the vibration information in detail, the diagnosis unit 14 does not store the vibration information. Accordingly, the diagnosis unit 14 does not require a large-capacity memory for storing large-capacity vibration information. Therefore, according to the fault diagnostic system 10 of the embodiment, even if the memory capacity of the diagnosis unit 14 is reduced and the diagnosis unit 14 is made inexpensive, it is possible to accurately detect abnormality of the diagnosis target device 2, and to accurately specify the type of abnormality occurring in the diagnosis target device 2, a part where abnormality occurs, or the like.

According to the fault diagnostic system 10 of the embodiment, the vibration information is transmitted to the reception station 16 from the diagnosis unit 14 which transmits the transmission request. Conversely, the vibration information is not transmitted to the reception station 16 from the diagnosis unit 14 which does not transmit the transmission request. Accordingly, in a case where there are multiple diagnosis target devices 2 and diagnosis units 14, if comparatively large-capacity vibration information is transmitted from all diagnosis units 14, the reception of the vibration information in the reception station 16 becomes difficult; however, it is possible to avoid the occurrence of such a problem.

According to the fault diagnostic system 10 of the embodiment, the reception station 16 does not receive the determination result from the diagnosis unit 14 after outputting the transmission request for vibration information. That is, the reception station 16 does not receive the determination result in a period during which the vibration information is received. With this, a communication load of the reception station 16 is reduced, and it is possible to more reliably receive vibration information.

Hereinbefore, the fault diagnostic system of the embodiment has been described. The embodiment is illustrative, and it will be understood by those skilled in the art that various modification examples can be made regarding combinations of the respective constituent elements or the respective processing processes and the modification examples still fall within the scope of the invention. Hereinafter, the modification examples are described.

### Modification Example 1

In the embodiment, although a case where the diagnosis unit 14 transmits the diagnosis target information to the reception station 16 if the transmission request is received from the reception station 16 has been described, the invention is not limited thereto. For example, if it is detected that abnormality occurs in the diagnosis target device 2, the diagnosis unit 14 may automatically transmit the vibration information to the reception station 16 detected by the sensor 12 after abnormality is detected. Furthermore, for example, if a terminal (external device), such as a desktop personal computer (PC), a laptop PC, a tablet PC, a dedicated analysis device, or a customer's control device, is connected to the diagnosis unit 14 in a wired or wireless manner, the diagnosis unit 14 may automatically the vibration information detected by the sensor 12 after the connection to this terminal. According to this example, since it is not necessary to designate the diagnosis unit 14 which transmits the transmission request for vibration information, a load on the user is reduced. In this case, the terminal connected to the diagnosis unit 14 may have some of the functions of the reception station 16. Specifically, the terminal connected to the diagnosis unit 14 may have the functions of the analysis processing unit 44. The terminal connected to the diagnosis unit 14 may have the functions of the diagnosis target information request unit 40. In this case, if the transmission request is received from the terminal connected to the diagnosis unit 14, the diagnosis unit 14 may transmit the diagnosis target information to this terminal.

In the embodiment, although a case where the reception station 16 transmits the transmission request for vibration information to the diagnosis unit 14 based on an input from the user has been described, the invention is not limited thereto. For example, if the determination result indicating that abnormality occurs is received from the diagnosis unit 14, the reception station 16 may automatically transmit the transmission request for vibration information to the diagnosis unit 14 without depending on an input from the user.

### Modification Example 2

Though not particularly mentioned in the embodiment, a terminal, such as a desktop PC, a laptop PC, a tablet PC, a dedicated analysis device, or a customer's control device, may be connected to the reception station 16 in a wired or wireless manner. In this case, the terminal connected to the reception station 16 may execute some of the functions of the reception station 16. For example, the functions of the diagnosis target information request unit 40, the diagnosis target information storage unit 48, or the analysis processing unit 44 of the reception station 16 may not be provided in the reception station 16, and may be executed by the terminal connected to the reception station 16. In this case, the terminal receives the designation of the diagnosis unit 14, which requests the transmission of the vibration information, from the user and transmits the transmission request for vibration information to the designated diagnosis unit 14 through the reception station 16. The vibration information transmitted from the diagnosis unit 14 through the reception station 16 is stored, analysis is executed based on the stored vibration information, and the analysis result is displayed to the user. According to the above configuration, since a memory storing the vibration information or an analysis processing function is not required in the reception station 16, it is possible to simplify the configuration of the reception station 16 and to make the reception station 16 inexpensive.

### Modification Example 3

In the embodiment, although a case where the fault diagnostic system 10 performs diagnosis of whether or not abnormality occurs in the diagnosis target device 2 based on vibration occurring in the diagnosis target device 2 has been described, the invention is not limited thereto. For example, the fault diagnostic system 10 may perform diagnosis of whether or not abnormality occurs in the diagnosis target device 2 based on at least one of a motor current, a temperature, or an iron powder concentration of lubricating oil of the diagnosis target device 2 instead of vibration occurring in the diagnosis target device 2 or in addition to vibration occurring in the diagnosis target device 2. That is, at least one of information relating to the motor current, the temperature, or the iron powder concentration of lubricating oil may be used as the diagnosis target information instead of information relating to vibration or in addition to information relating to vibration.

For example, in a case of performing diagnosis of whether or not abnormality occurs based on the temperature of the diagnosis target device 2 instead of vibration of the diagnosis target device 2, a temperature sensor is used as the sensor 12. If the temperature of the diagnosis target device 2 exceeds a predetermined abnormality threshold, the abnormality determination unit 26 of the diagnosis unit 14 determines that abnormality occurs in the diagnosis target device 2.

### Modification Example 4

Though not particularly mentioned in the embodiment, the diagnosis target information request unit 40 of the reception station 16 may send a transmission request for diagnosis information to the diagnosis unit 14 designated by the user, sends a request to stop the transmission of the determination result to each diagnosis unit 14, and may stop the transmission of the determination result from each diagnosis unit 14.

### Modification Example 5

In the embodiment, although one diagnosis unit 14 is provided for one diagnosis target device (gear motor) 2, the invention is not limited thereto, and one diagnosis unit 14 may be provided for a plurality of diagnosis target devices 2. In this case, the diagnosis unit 14 determines abnormality of the respective corresponding diagnosis target devices 2 based on the diagnosis target information (vibration information) received from the respective sensors 12 provided in a plurality of corresponding diagnosis target devices 2 and transmits the determination results to the reception station 16. If the transmission request for vibration information is received from the reception station 16, the diagnosis unit 14 transmits the vibration information generated by a plurality of corresponding sensors 12 to the reception station 16. Furthermore, the reception station 16 may receive the designation of the gear motor 2 which requests the transmission of the vibration information and may transmits the transmission request for vibration information of the designated gear motor 2 to the diagnosis unit 14. If the transmission request is received, the diagnosis unit 14 transmits only the vibration information of the sensor 12 provided in the designated gear motor 2 among a plurality of corresponding gear motors 2 to the reception station 16. Furthermore, the diagnosis unit 14 may transmit only the vibration information of the sensor 12 provided in the gear motor 2 determined to be abnormal among a plurality of corresponding gear motors 2 to the reception station 16.

It should be understood that the invention is not limited to the above-described embodiment, but may be modified into various forms on the basis of the spirit of the invention. Additionally, the modifications are included in the scope of the invention.

What is claimed is:

1. A fault diagnostic system comprising:
a sensor which is provided in each of a plurality of diagnosis target devices and detects diagnosis target information of the corresponding diagnosis target device; and
a diagnosis unit which is provided for one or a plurality of diagnosis target devices and determines whether or not abnormality occurs in the corresponding diagnosis target device based on the diagnosis target information detected by the sensor,
wherein the diagnosis unit outputs a determination result to the outside, and when a specific condition is established, outputs diagnosis target information detected by the sensor after the specific condition is established.

2. The fault diagnostic system according to claim 1, further comprising:
an external device which is connectable to the diagnosis unit,
wherein the external device receives determination results from a plurality of diagnosis units and outputs a transmission request for diagnosis target information to a specific diagnosis unit, and
the diagnosis unit which receives the transmission request for diagnosis target information transmits, to the external device, diagnosis target information detected by the sensor after the transmission request is received.

3. The fault diagnostic system according to claim 2,
wherein the external device does not receive a determination result after the transmission request for diagnosis target information is output.

4. The fault diagnostic system according to claim 2,
wherein the external device receives designation of a specific diagnosis unit which outputs a transmission request for diagnosis target information.

5. The fault diagnostic system according to claim 1, further comprising:
an external device which is connectable to the diagnosis unit,
wherein the diagnosis unit outputs a determination result to the outside in a wireless manner, and on a condition that the external device is connected in a wired manner, transmits subsequent diagnosis target information to the external device.
